(19) United States
(12) Patent Application Publication
(10) Pub. No.: US 2015/0277692 A1
(43) Pub. Date: Oct. 1, 2015

(54) METHOD FOR MOVING ICON ON TERMINAL AND TERMINAL

(71) Applicant: DONGGUAN GOLDEX COMMUNICATION TECHNOLOGY CO., LTD., Dongguan, Guangdong (CN)

(72) Inventor: Lirong Liu, Dongguan (CN)

(21) Appl. No.: 14/372,215

(22) PCT Filed: Oct. 21, 2013
(86) PCT No.: PCT/CN2013/085554

§ 371 Date: May 21, 2015

(30) Foreign Application Priority Data
Jan. 23, 2013 (CN) 201310027292.3

(51) Int. Cl. G06F 3/0486; G06F 3/0488; G06F 3/0481

(52) U.S. Cl. CPC G06F 3/0486; G06F 3/04817; G06F 3/0488

(57) ABSTRACT

The present invention discloses a method for moving an icon on a terminal, including: setting a to-be-moved icon as a floating icon according to a touch operation of the icon on a first icon display page; detecting an operation of switching, by a user, the icon display page, switching the icon display page according to the operation of switching, by the user, the icon display page, and keeping the floating icon immovable in an original position; switching the icon display page to a second icon display page, and responding to the touch operation by the user to the floating icon to insert the floating icon in a proper position on the second icon display page. The present invention further discloses a terminal. The efficiency of switching an icon display page and accuracy of moving the icon is improved; the user experience of moving the icon is enhanced.

This application claims priority to Chinese Patent Application No. 201310027292.3, filed with the Chinese Patent Office on Jan. 23, 2013 and entitled “METHOD FOR MOVING ICON ON TERMINAL AND TERMINAL”, the content of which is incorporated herein by reference in its entirety for all purposes.

### TECHNICAL FIELD

The present disclosure relates to the field of electronic technologies, and in particular, to a method for moving an icon on a terminal and a terminal

### BACKGROUND

With increasingly abundant existing terminal products and increasingly diverse terminal application programs, there are more and more icons on a screen desktop of an electronic product. However, the icons which can be showed on a single icon display page of a screen desktop of a terminal are limited, so that the icons of all application programs generally need to be displayed on a plurality of icon display pages. In the case of displaying the icons on the plurality of icon display pages, moving the icons becomes an inevitable event.

A method for moving an icon in the prior art mainly includes: dragging the icon by using a mouse; switching an icon display page by determining a direction and a speed of dragging, by a user, the mouse; dragging the icon to a proper icon display page, and inserting the icon in a corresponding position. In the prior art, when a terminal user needs to move an icon of an application program, the terminal user needs to drag the icon to an edge of the icon display page so as to switch the icon display page, and drag the icon, which needs to be moved, to a proper icon display page. In the prior art, in the method for moving the icon of switching the icon display page by dragging the icon to the edge of the icon display page, dragging the icon to the proper page and inserting the icon in the corresponding position, misoperation problems of moving icon, such as misoperation of dragging icon, low efficiency of switching the icon display page, and a position error of inserting the icon, may be caused to a large extent.

### SUMMARY

Embodiments of the present invention provide a method for moving an icon on a terminal and a terminal, which can keep a to-be-moved icon immovable in an original position when an icon display page is switched, and after switching the icon display page to a proper position, insert the to-be-moved icon in a corresponding position, thereby increasing the efficiency of switching the icon display page and the accuracy of moving the icon, and enhancing the user experience of moving the icon.

An embodiment of the present invention provides a method for moving an icon on a terminal, including:

setting a to-be-moved icon as a floating icon according to a touch operation of the icon on a first icon display page;

detecting an operation of switching, by a user, the icon display page, switching the icon display page according to the operation of switching, by the user, the icon display page, and keeping the floating icon immovable in an original position; and

switching the icon display page to a second icon display page, and responding to the touch operation by the user to the floating icon to insert the floating icon in a proper position on the second icon display page.

An embodiment of the present invention further provides a terminal, including:

an icon setting module, configured to set a to-be-moved icon as a floating icon according to a touch operation of an icon on a first icon display page;

a page switching module, configured to detect an operation of switching, by a user, an icon display page, switch the icon display page according to the operation of switching, by the user, the icon display page, and keep the floating icon immovable in an original position; and

a moving module, configured to switch the icon display page to a second icon display page, and respond to the touch operation by the user to the floating icon to insert the floating icon in a proper position on the second icon display page.

According to the embodiments of the present invention, the to-be-moved icon on the first icon display page is set as the floating icon, the floating icon is kept immovable in the original position when the icon display page is switched, and after the icon display page is switched to the second icon display page, the floating icon is inserted in the corresponding position. By adopting the method for moving an icon on a terminal according to the embodiments of the present invention, the efficiency of switching the icon display page is increased, the accuracy of moving the icon is improved, and the user experience of moving the icon is enhanced.

### BRIEF DESCRIPTION OF DRAWINGS

To more clearly describe the technical solutions of the embodiments of the present invention, the following briefly introduces the drawings required to be used in the description of the embodiments, apparently, the drawings described below are some embodiments rather than all of the embodiments of the present invention, and a person ordinarily skilled in the art without creative efforts may further obtain other drawings according to these drawings.

FIG. 1 is a schematic flowchart of a first embodiment of a method for moving an icon on a terminal according to an embodiment of the present invention;

FIG. 2 is a schematic flowchart of a second embodiment of a method for moving an icon on a terminal according to an embodiment of the present invention;

FIG. 3 is a schematic flowchart of a third embodiment of a method for moving an icon on a terminal according to an embodiment of the present invention;

FIG. 4 is a schematic structural diagram of a first embodiment of a terminal according to an embodiment of the present invention;

FIG. 5 is a schematic structural diagram of a second embodiment of a terminal according to an embodiment of the present invention; and

FIG. 6 is a schematic structural diagram of a third embodiment of a terminal according to an embodiment of the present invention.

### DESCRIPTION OF EMBODIMENTS

The following clearly and completely describes the technical solutions in the embodiments of the present invention with reference to the accompanying drawings in the embodiments of the present invention. Apparently, the described embodiments are a part rather than all of the embodiments of the present invention. All other embodiments obtained by a person ordinarily skilled in the art based on the embodiments of the present invention without creative efforts shall fall within the protection scope of the present invention.

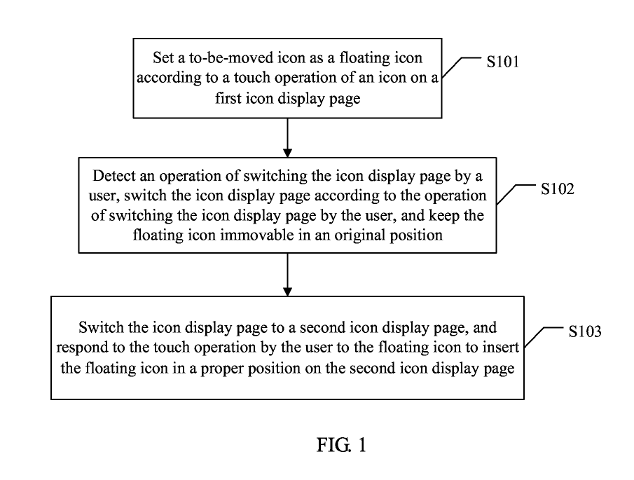

Referring to FIG. 1, FIG. 1 is a schematic flowchart of a first embedment of a method for moving an icon on a terminal according to an embodiment of the present invention. The method for moving an icon on a terminal according to the embodiment includes steps:

S101, setting a to-be-moved icon as a floating icon according to a touch operation of an icon on a first icon display page.

S102, detecting an operation of switching, by a user, the icon display page, and switching the icon display page according to the operation of switching, by the user, the icon display page, and keeping the floating icon immovable in an original position.

S103, switching the icon display page to a second icon display page, and responding to the touch operation by the user to the floating icon to insert the floating icon in a proper position on the second icon display page.

During specific implementation, when the touch operation of the icon on a current icon display page (that is, the first icon display page) is detected, it can be known that which icon is the icon that the user wants to move according to detected touch operation of the icon, that is, the touch operation of this icon is a to-be-moved operation (such as long press), and then the icon is set as the to-be-moved icon; the to-be-moved icon is set as the floating icon before responding to an operation of moving an icon is performed, and the floating icon may be placed at the top of an icon layer, and be staggered for a certain distance from an icon in the original position for performing distinguishing.

During specific implementation, the more application programs are downloaded by the user, the more corresponding program icons exist, and the number of the icon display pages possibly exceeds one. The icon can be moved by the user and can be directly switched on a plurality of icon display pages until a proper icon display page and a proper icon placing position are found, then the to-be-moved icon is inserted in a corresponding position, and responding to the operation of switching the icon display page by the user can be performed after the to-be-moved icon is set as the floating icon according to the foregoing method. By detecting the operation of switching the icon display page by the user, the icon display page may be automatically switched according to the operation of switching the icon display page by the user, and the floating icon is kept immovable in the original position during a process of switching the icon display page. For example, if the floating icon is in a second icon position on the first icon page before the icon display page is switched, when the current icon display page is switched to the second icon page, the floating icon shall be in a second icon position of the second icon page; and if the current icon display page is switched to a third icon page, the floating icon is still in a second icon position of the third icon page. The icon display page is automatically switched according to the operation of switching the icon display page by the user; and after the icon display page is switched to the proper icon page (that is, the icon display page is switched to the second icon display page from the first icon display page), responding to the touch operation of the user to the floating icon can be performed, so as to insert the floating icon in the proper position on the current icon display page. During specific implementation, the touch operation of the user to the floating icon includes: performing point-touch on the floating icon, dragging the floating icon or other operation manners. If the touch operation of the user to the floating icon is an operation of performing point-touch on the floating icon, then the icon in the current icon display page (that is, the second icon display page) which is the closest to the floating icon is determined according to a current position of the floating icon, the floating icon is inserted in an icon position closest to the floating icon, a floating state of the floating icon is cancelled, an icon of the floating icon in the original position is deleted, and the operation of moving the icon is completed. If the touch operation of the user to the floating icon is an operation of dragging the floating icon, a position in which the floating icon is released by the user is determined according to the operation of dragging the floating icon, and the floating icon is inserted in the icon position, the floating state of the floating icon is cancelled, the icon of the floating icon on the original position is deleted, and the operation of moving the icon is completed.

According to the embodiment of the present invention, the to-be-moved icon is set as the floating icon; the floating icon floats at the top of the icon layer, and is kept immovable in the original position in the process of switching the icon display page, and after the current icon display page (that is, the first icon display page) is switched to the proper icon page (that is, the second icon display page), the floating icon is inserted in the proper position, and exits the floating state, thereby completing the operation of moving the icon. The embodiment improves the accuracy of moving the icon, and enhances the user experience of moving the icon.

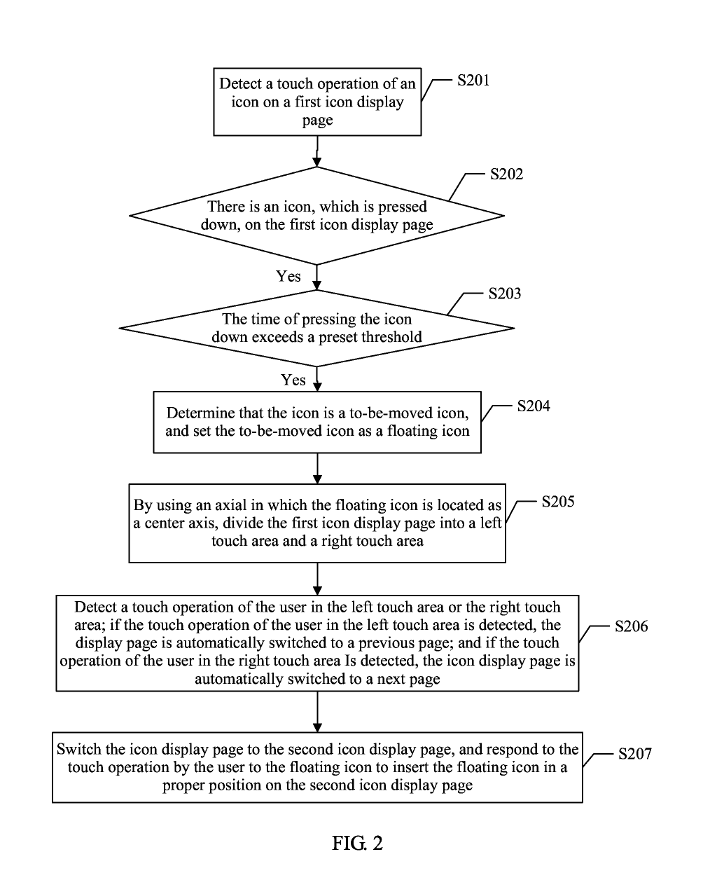

Referring to FIG. 2, FIG. 2 is a schematic flowchart of a second embodiment of a method for moving an icon on a terminal according to an embodiment of the present invention. The method for moving an icon on a terminal according to the embodiment includes steps:

S201, detecting a touch operation of an icon on a first icon display page.

S202, determining whether there is an icon, which is pressed down, on the first icon display page; and if there is an icon, which is pressed down, on the first icon display page, then step S203 is executed.

S203, determining whether time of pressing the icon down exceeds a preset time threshold; and if the time of pressing the icon down exceeds the preset time threshold, then step S204 is executed.

S204, determining that the icon is a to-be-moved icon, and setting the to-be-moved icon as a floating icon.

S205, dividing the first icon display page into a left touch area and a right touch area by using an axis in which the floating icon is located as a center axis.

S206, detecting a touch operation of the user in the left touch area or the right touch area, if the touch operation of the user in the left touch area is detected, the icon display page is automatically switched to a previous page, and if the touch operation of the user in the right touch area is detected, the icon display page is automatically switched to a next page.

S207, switching the icon display page to a second icon display page, and responding to a touch operation by the user to the floating icon to insert the floating icon in a proper position on the second icon display page.

During specific implementation, when the touch operation of the icon on a current icon display page (that is, the first icon display page) is detected, it can be known from a determination that whether there is the icon, which is pressed down, on the current icon display page according to detected touch operation of the icon; if it is determined that there is the icon, which is pressed down, on the current icon display page, whether the time of pressing the icon down exceeds the preset time threshold can be further determined; and if it is known from a determination that the time of pressing the icon down exceeds the preset time threshold, the icon can be set as the to-be-moved icon, and the to-be-moved icon is set as the floating icon before responding to the operation of moving the icon is performed, and the floating icon may be placed at the top of an icon layer, and be staggered for a certain distance from the original position icon for performing distinguishing.

During specific implementation, the more application programs are downloaded by the user, the more corresponding program icons exist, and the number of the icon display pages possibly exceeds one. The icon can be moved by the user and can be directly switched on a plurality of icon display pages until a proper icon display page and a proper icon placing position are found, then the to-be-moved icon is inserted in a corresponding position, and responding to the operation of switching the icon display page by the user can be performed after the to-be-moved icon is set as a floating icon according to the foregoing method. During specific implementation, by using an axial in which the floating icon is located as a center axis, the current icon display page can be divided into a left touch area and a right touch area, the user can switch the icon display page to the previous page through a touch operation in the left touch area, and switch the icon display page to the next page through a touch operation in the right touch area. During specific implementation, the touch operation of the user in the left touch area or the right touch area is detected, and the icon display page is switched according to the touch operation of the user. If the touch operation of the user in the left touch area is detected, the icon display page is automatically switched to the previous page; and if the touch operation of the user in the right touch area is detected, the icon display page is automatically switched to the next page and the floating icon is kept immovable in the original position during a process of switching the icon display page. For example, if the floating icon is in a second icon position on the first icon page before the icon display page is switched, when the touch operation of the user in the right touch area is detected, the current icon display page is switched to the second icon page and the floating icon is kept in a second icon position of the second icon page; and when the current icon display page is switched to a third icon page, the floating icon is still in a second icon position of the third icon page. After the icon display page is automatically switched according to the operation of switching the icon display page by the user and the icon display page is switched to a proper icon page (that is, the icon display page is switched to the second icon display page from the first icon display page), responding to the touch operation of the user to the floating icon can be performed to insert the floating icon in the proper position on the current icon display page. During specific implementation, the touch operation of the user to the floating icon includes: performing point-touch on the floating icon, dragging the floating icon or other operation manners. If the touch operation of the user to the floating icon is performing point-touch on the floating icon, then the icon in the current icon display page (that is, the second icon display page) which is the closest to the floating icon is determined according to a current position of the floating icon, the floating icon is inserted in an icon position closest to the floating icon, a floating state of the floating icon is cancelled, an icon of the floating icon in the original position is deleted, and the operation of moving the icon is completed. If the touch operation of the user to the floating icon is an operation of dragging the floating icon, a position in which the floating icon is released by the user is determined according to the operation of dragging the floating icon, and the floating icon is inserted in the icon position, the floating state of the floating icon is cancelled, the icon of the floating icon in the original position is deleted, and thus the operation of moving the icon is completed.

According to the embodiment, the to-be-moved icon can be identified by detecting the touch operation of the user on the icon display page, and be set as the floating icon; the floating icon floats at the top of the icon layer, and is kept immovable in the original position in the process of switching the icon display page. The icon display page is divided into the left touch area and the right touch area, the icon display page is switched by detecting the touch operation by the user in each of the left touch area and the right touch area, the floating icon is inserted in the proper position after the icon display page is switched to a proper icon page, and exits a floating state, thereby completing the operation of moving the icon. The embodiment increases the efficiency of switching the icon display page, and improves the accuracy of moving the icon, and enhances the user experience of moving the icon.

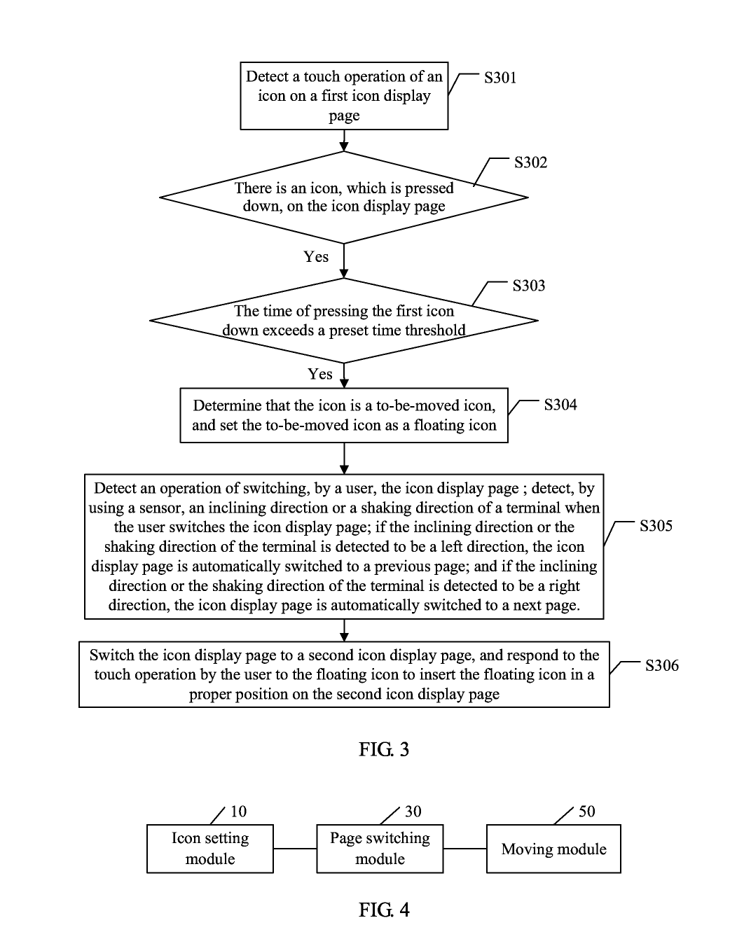

Referring to FIG. 3, FIG. 3 is a schematic flowchart of a third embodiment of a method for moving an icon on a terminal according to an embodiment of the present invention. The method for moving an icon on a terminal according to the embodiment includes steps:

S301, detecting a touch operation of an icon on a first icon display page.

S302, determining whether there is an icon, which is pressed down, on the first icon display page; and if there is an icon, which is pressed down, on the first icon display page, step S303 is executed.

S303, determining whether time of pressing the icon down exceeds a preset time threshold; if the time of pressing the icon down exceeds the preset time threshold, then step S304 is executed.

S304, determining that the icon is a to-be-moved icon, and setting the to-be-moved icon as a floating icon.

S305, detecting an operation of switching, by a user, the icon display page, and detecting, by using a sensor, an inclining direction or a shaking direction of a terminal when the user switches the icon display page; if the inclining direction or the shaking direction of the terminal is detected to be a left direction, then the icon display page is automatically switched to a previous page; and if the inclining direction or shaking direction of the terminal is detected to be a right direction, then the icon display page is automatically switched to the next page.

S306, switching the icon display page to the second icon display page, and responding to the touch operation by the user to the floating icon to insert the floating icon in a proper position on the second icon display page.

During specific implementation, when the touch operation of the icon on a current icon display page (that is, the first icon display page) is detected, it can be known from a determination that whether there is the icon, which is pressed down, on the current icon display page according to detected touch operation of the icon; if it is determined that there is the icon, which is pressed down, on the current icon display page, whether the time of pressing the icon down exceeds the preset time threshold can be further determined; and if it is known from a determination that the time of pressing the icon down exceeds the preset time threshold, the icon can be set as the to-be-moved icon, and the to-be-moved icon is set as the floating icon before responding to the operation of moving the icon, and the floating icon can be put at the top of an icon layer, and be staggered for a certain distance from an original position icon for performing distinguishing.

During specific implementation, the more application programs are downloaded by the user, the more corresponding program icons exist, and the number of the icon display pages possibly exceeds one. The icon can be moved by the user and can be directly switched on a plurality of icon display pages until a proper icon display page and a proper icon placing position are found, then the to-be-moved icon is inserted in a corresponding position, and the operation of switching the icon display page by the user can be started being responded after the to-be-moved icon is set as the floating icon according to the foregoing method. During specific implementation, the user may switch the icon display page in manners of inclining or shaking the terminal When the operation of switching the icon display page by the user is detected, the inclining direction or shaking direction of the terminal can be detected by using a sensor when the user switches the icon display page; if the inclining direction or the shaking direction of the terminal is detected to be the left direction, then the icon display page is automatically switched to the previous page; and if the inclining direction or the shaking direction of the terminal is detected to be the right direction, then the icon display page is automatically switched to the next page and the floating icon is kept immovable in the original position in the process of switching the icon display page. Wherein, the sensor may include a gravity sensor, a gyroscope and other sensors capable of detecting the movement state of the terminal For example, if the floating icon is in a second icon position on the first icon page before the icon display page is switched, when the sensor detects that the terminal inclines rightwards, the current icon display page is switched to the second icon page and the floating icon is kept in a second icon position of the second icon page; and when the current icon display page is switched to a third icon page, the floating icon is still in a second icon position of the third icon page. The icon display page is automatically switched according to the operation of switching the icon display page by the user; and after the icon display page is switched to a proper icon page (that is, the icon display page is switched to the second icon display page from the first icon display page), responding to the touch operation of the user to the floating icon can be performed to insert the floating icon in the proper position on the current icon display page. During specific implementation, the touch operation of the user to the floating icon includes: performing point-touch on the floating icon, dragging the floating icon or other operation manners. If the touch operation of the user to the floating icon is an operation of performing point-touch on the floating icon, then the icon in the current icon display page (that is, the second icon display page) which is the closest to the floating icon is determined according to a current position of the floating icon, the floating icon is inserted in an icon position closest to the floating icon, a floating state of the floating icon is cancelled, and an icon of the floating icon on an original position is deleted, thereby completing the operation of moving the icon. If the touch operation of the user to the floating icon is an operation of dragging the floating icon, a position in which the floating icon is released by the user is determined according to the operation of dragging the floating icon, and the floating icon is inserted in the icon position, the floating state of the floating icon is cancelled, and the icon of the floating icon on the original position is deleted, thereby completing the operation of moving the icon.

According to the embodiment, the to-be-moved icon can be identified by detecting the touch operation of the user on the icon display page, and be set as the floating icon; and the floating icon floats at the top of the icon layer, and is kept immovable in the original position in a process of switching the icon display page. The inclining direction or the shaking direction of the terminal is detected by using the sensor, so as to determine the operation of switching the icon display page by the user, and the floating icon is inserted in the proper position after the icon display page is switched to a proper icon page, and exits a floating state, thereby completing the operation of moving the icon. The embodiment increases the efficiency of switching an icon display page, improves the accuracy of moving the icon, and enhances the user experience of moving the icon.

Referring to FIG. 4, FIG. 4 is a schematic structural diagram of a first embodiment of a terminal according to an embodiment of the present invention. The terminal according to the embodiment includes:

an icon setting module 10, configured to set a to-be-moved icon to a floating icon according to a touch operation of an icon on a first icon display page;

a page switching module 30, configured to detect an operation of switching, by a user, an icon display page, and switch the icon display page according to the operation of switching, by the user, the icon display page, and keep the floating icon immovable in an original position; and

a moving module 50, configured to switch the icon display page to a second icon display page, and respond to the touch operation by the user to the floating icon to insert the floating icon in a proper position on the second icon display page.

During specific implementation, by detecting the touch operation of the icon on a current icon display page (that is, the first icon display page), the icon setting module 10 can obtain which icon is the icon that the user wants to move according to detected touch operation of the icon, that is, the touch operation of the icon is a to-be-moved operation (such as long press), and then the icon is set as the to-be-moved icon; the to-be-moved icon is set as the floating icon before responding to the operation of moving the icon is performed, the floating icon can be placed at the top of an icon layer, and be staggered for a certain distance from an icon at the original position for performing distinguishing.

During specific implementation, the more application programs are downloaded by the user, the more corresponding program icons exist, and the number of the icon display pages possibly exceeds one. The icon can be moved by the user and can be directly switched on a plurality of icon display pages until a proper icon display page and a proper icon placing position are found, then the to-be-moved icon is inserted in a corresponding position, and responding to the operation of switching the icon display page by the user can be performed after the to-be-moved icon is set as the floating icon according to the foregoing method. By detecting the operation of switching the icon display page by the user, the page switching module 30 can automatically switch the icon display page according to the operation of switching the icon display page by the user, and keep the floating icon set by the icon setting module 10 immovable in the original position during the process of switching the icon display page. For example, if the floating icon is in a second icon position on the first icon page before the icon display page is switched, when the current icon display page is switched to the second icon page, the floating icon shall be in a second icon position of the second icon page, and when the current icon display page is switched to a third icon page, the floating icon is still in a second icon position on the third icon page. The page switching module 30 automatically switches the icon display page according to the operation of switching the icon display page by the user; and after the page switching module 30 switches the icon display page to a proper icon page (that is, the icon display page is switched to the second icon display page from the first icon display page), the moving module 50 can respond to the touch operation of the user to the floating icon to insert the floating icon in the proper position in the current icon display page. During specific implementation, the touch operation of the user to the floating icon includes: performing point-touch on the floating icon, dragging the floating icon or other operation manners. If the touch operation of the user to the floating icon is an operation of performing point-touch on the floating icon, the moving module 50 determines that which icon on the current icon display page (that is, the second icon display page) is the closest to the floating icon according to a current position of the floating icon, and inserts the floating icon in an icon position closest to the floating icon, and cancels the floating state of the floating icon, and deletes an icon of the floating icon on an original position, thereby completing the operation of moving the icon. If the touch operation of the user to the floating icon is an operation of dragging the floating icon, the moving module 50 determines a position in which the floating icon is released by the user according to the operation of dragging the floating icon, and inserts the floating icon in the icon position, and cancels the floating state of the floating icon, and deletes the icon of the floating icon on the original position, thereby completing the operation of moving the icon.

According to the embodiment, the icon setting module 10 sets the to-be-moved icon as the floating icon, and the floating icon floats at the top of the icon layer; the page switching module 30 keeps the floating icon immovable in the original position during the process of switching the icon display page, and after the page switching module 30 switches the current icon display page (that is, the first icon display page) to the proper icon page (that is, the second icon display page), the moving module 50 inserts the floating icon in the proper position, and enables the floating icon to exit a floating state, thereby completing the operation of moving the icon. The embodiment improves the accuracy of moving the icon, and enhances the user experience of moving the icon.

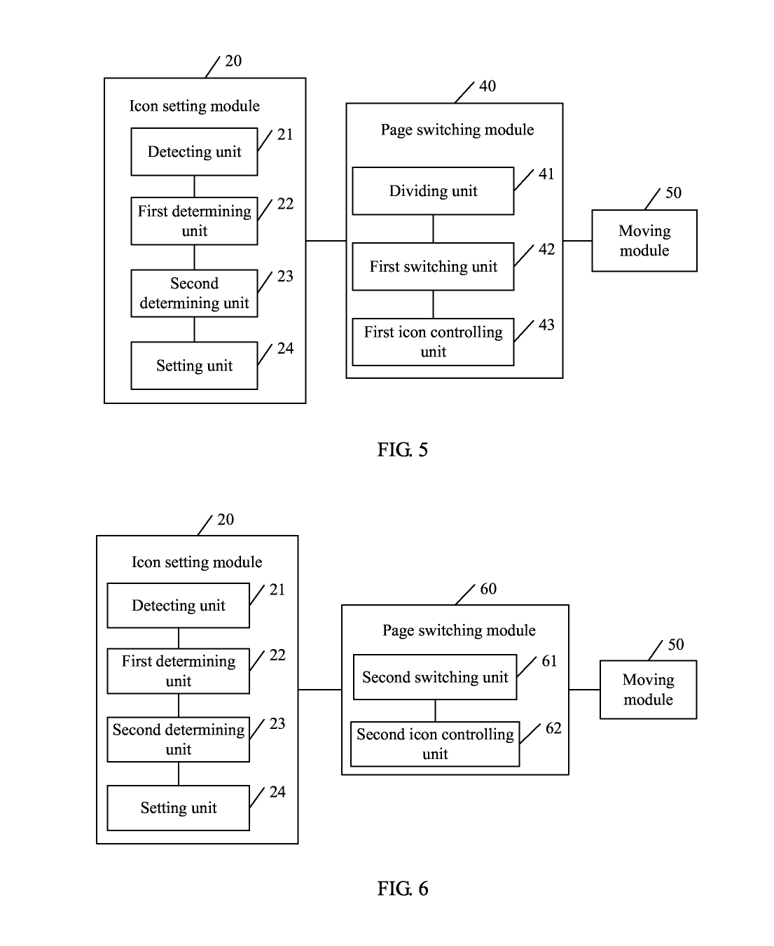

Referring to FIG. 5, FIG. 5 is a schematic structural diagram of a second embodiment of a terminal according to an embodiment of the present invention. The terminal according to the embodiment includes:

an icon setting module 20, configured to set a to-be-moved icon as a floating icon according to a touch operation of an icon on a first icon display page;

a page switching module 40, configured to detect an operation of switching, by a user, an icon display page, and switch the icon display page according to the operation of switching, by the user, the icon display page, and keep the floating icon immovable in an original position; and

a moving module 50, configured to switch the icon display page to a second icon display page, and respond to the touch operation by the user to the floating icon to insert the floating icon in a proper position on the second icon display page.

Where, the icon setting module 20 includes:

a detecting unit 21, configured to detect the touch operation of the icon on the first icon display page;

a first determining unit 22, configured to determine whether there is an icon, which is pressed down, on the icon display page according to the touch operation of the icon;

a second determining unit 23, configured to further determine whether time of pressing the icon down exceeds a preset time threshold when the first determining unit 22 determines that there is the icon, which is pressed down, on the icon display page; and

a setting unit 24, configured to determine that the icon is a to-be-moved icon and set the to-be-moved icon as a floating icon when the second determining unit 23 determines that the time of pressing the icon down exceeds the preset time threshold.

Where, the page switching module 40 includes:

a dividing unit 41, configured to divide the icon display page into a left touch area and a right touch area by using an axial in which the floating icon is located as a center axis;

a first switching unit 42, configured to detect a touch operation of the user in the left touch area or the right touch area, if the touch operation of the user in the left touch area is detected, the icon display page is automatically switched to a previous page, and if the touch operation of the user in the right touch area is detected, the icon display page is automatically switched to a next page; and

a first icon controlling unit 43, configured to keep the floating icon immovable in the original position during a process of switching the icon display page by the first switching unit.

During specific implementation, the detecting unit 21 detects the touch operation of the icon on the current icon display page (that is, the first icon display page), the detection unit 21 sends a touch operation result of the icon to the first determining unit 22; the first determining unit 22 can determine, according to detected touch operation result of the icon, to obtain whether there is an icon, which is pressed down, on the current icon display page; if the first determining unit 22 determines that there is the icon, which is pressed down, on the current icon display page, the second determining unit 23 can further determine whether the time of pressing the icon down exceeds a preset time threshold; if the second determining unit 23 determines that the time of pressing the icon down exceeds the preset time threshold, the setting unit 24 can set the icon as a to-be-moved icon, and set the to-be-moved icon as a floating icon before responding to the operation of moving the icon is performed, and the floating icon can be placed at the top of an icon layer, and be staggered for a certain distance from the icon in the original position for performing distinguishing.

During specific implementation, the more application programs are downloaded by the user, the more corresponding program icons exist, and the number of the icon display pages possibly exceeds one. The icon can be moved by the user and can be directly switched on a plurality of icon display pages until a proper icon display page and a proper icon placing position are found, then the to-be-moved icon is inserted in a corresponding position, and responding to the operation of switching the icon display page by the user can be performed after the to-be-moved icon is set as the floating icon according to the foregoing method. During specific implementation, the dividing unit 41 can divide the current icon display page into a left touch area and a right touch area by using an axial in which the floating icon is located as a center axis, the user can switch the icon display page to the previous page through a touch operation in the left touch area, and switch the icon display page to the next page through a touch operation in the right touch area. During specific implementation, by detecting the touch operation of the user in the left touch area or the right touch area, the first switching unit 42 switches the icon display page according to the touch operation of the user, if the touch operation of the user in the left touch area is detected, the icon display page is automatically switched to the previous page, and if the touch operation of the user in the right touch area is detected, the icon display page is automatically switched to the next page. The first icon controlling unit 43 keeps the floating icon immovable in the original position during the process of switching the icon display page by the first switching unit. For example, if the floating icon is in a second icon position on the first icon page before the icon display page is switched, when the first switching unit 42 detects the touch operation of the user in the right touch area, the current icon display page is switched to the second icon page, the first icon controlling unit 43 shall keep the floating icon in a second icon position on the second icon page, and when the current icon display page is switched to a third icon page, the floating icon is still in a second icon position on the third icon page. The icon display page is automatically switched according to the operation of switching the icon display page by the user; after the icon display page is switched to a proper icon page, the moving module 50 can respond to the touch operation of the user to the floating icon, and the floating icon is inserted in the proper position on the current icon display page. During specific implementation, the touch operation of the user to the floating icon includes: performing point-touch on the floating icon, dragging the floating icon or other operation manners. If the touch operation of the user to the floating icon is an operation of performing point-touch on the floating icon, the moving module 50 determines that which icon in the current icon display page (that is, the second icon display page) is the closest to the floating icon according to a current position of the floating icon, and inserts the floating icon in an icon position closest to the floating icon, and cancels the floating state of the floating icon, and deletes an icon of the floating icon on an original position, thereby completing the operation of moving the icon. If the touch operation of the user to the floating icon is an operation of dragging the floating icon, the moving module 50 determines a position in which the floating icon is released by the user according to the operation of dragging the floating icon, and inserts the floating icon in the icon position, and cancels the floating state of the floating icon, and deletes the icon of the floating icon on the original position, thereby completing the operation of moving the icon.

According to the embodiment, the icon setting module 20 can identify the to-be-moved icon by detecting the touch operation of the user on the icon display page, and set the to-be-moved icon to the floating icon; and the floating icon floats at the top of the icon layer, and the floating icon is kept immovable in the original position during the process of switching the icon display page. The page switching module 40 divides the icon display page into two touch areas and switches the icon display page by detecting the touch operation by the user in each of the two touch areas; after the page switching module 40 switches the icon display page to a proper icon page, the moving module 50 inserts the floating icon in the proper position, and enables the floating icon to exit a floating state, thereby completing the operation of moving the icon. The embodiment increases the efficiency of switching the icon display page, improves the accuracy of moving the icon, and enhances the user experience of moving the icon.

Referring to FIG. 6, FIG. 6 is a schematic structural diagram of a third embodiment of a terminal provided by an embodiment of the present invention. The terminal according to the embodiment includes:

an icon setting module 20, configured to set a to-be-moved icon to a floating icon according to a touch operation of an icon on a first icon display page;

a page switching module 60, configured to detect an operation of switching, by a user, an icon display page, and switch the icon display page according to the operation of switching, by the user, an icon display page, and keep the floating icon immovable in an original position; and

a moving module 50, configured to switch the icon display page to a second icon display page, respond to the touch operation by the user to the floating icon to insert the floating icon in a proper position on the second icon display page.

Where, the icon setting module 20 includes:

a detecting unit 21, configured to detect the touch operation of the icon on the first icon display page;

a first determining unit 22, configured to determine whether there is an icon, which is pressed down, on the first icon display page according to the touch operation of the icon;

a second determining unit 23, configured to further determine whether time of pressing the icon down exceeds a preset time threshold when the first determining unit 22 determines that there is an icon, which is pressed down, on the first icon display page; and

a setting unit 24, configured to determine that the icon is a to-be-moved icon and set the to-be-moved icon as a floating icon when the second determining unit 23 determines that the time of pressing the icon down exceeds the preset time threshold.

Where, the page switching module 60 includes:

a second switching unit 61, configured to detect, by using a sensor, an inclining direction or a shaking direction of a terminal when the user switches the icon display page, if the inclining direction of the shaking direction of the terminal is detected to be a left direction, then the icon display page is automatically switched to a previous page, and if the inclining direction or the shaking direction of the terminal is detected to be a right direction, then the icon display page is automatically switched to a next page; and

a second icon controlling unit 62, configured to keep the floating icon immovable in the original position during a process of switching the icon display page by the second switching unit 61.

During specific implementation, the detecting unit 21 detects the touch operation of the icon on the current icon display page (that is, the first icon display page), the detection unit 21 sends a touch operation result of the icon to the first determining unit 22, the first determining unit 22 can determine, according to detected touch operation result of the icon, to obtain whether there is an icon, which is pressed down, on the current icon display page; if the first determining unit determines that there is the icon, which is pressed down, on the current icon display page, the second determining unit 23 can further determine whether the time of pressing the icon down exceeds a preset time threshold; if the second determining unit determines that the time of pressing the icon down exceeds the preset time threshold, the setting unit 24 can set the icon as the to-be-moved icon, and set the to-be-moved icon as the floating icon before responding to the operation of moving the icon is performed, and the floating icon can be put at the top of an icon layer, and be staggered for a certain distance from the icon in the original position for performing distinguishing.

During specific implementation, the more application programs are downloaded by the user, the more corresponding program icons exist, and the number of icon display pages possibly exceeds one. The icon can be moved by the user can be directly switched on a plurality of icon display pages until a proper icon display page and a proper icon placing position are found, then the to-be-moved icon is inserted in a corresponding position, and responding to the operation of switching the icon display page by the user can be performed after the to-be-moved icon is set as the floating icon according to the foregoing method. During specific implementation, the user can switch the icon display page in manners of inclining or shaking the terminal. When the operation of switching the icon display page by the user is detected, the second switching unit 61 can detect, by using the sensor, the inclining direction or the shaking direction of the terminal when the user switches the icon display page; if the inclining direction or the shaking direction of the terminal is detected to be the left direction, then the icon display page is automatically switched to the previous page, and if the inclining direction or the shaking direction of the terminal is detected to be the right direction, then the icon display page is automatically switched to the next page. The second icon controlling unit keeps the floating icon immovable in the original position during the process of switching the icon display page by the second switching unit 61. Wherein, the sensor may include a gravity sensor, a gyroscope and other sensors capable of detecting the movement state of the terminal For example, if the floating icon is in a second icon position on the first icon page before the icon display page is switched, when the second switching unit 61 detects that the terminal inclines rightwards by using the sensor, the current icon display page is switched to the second icon page, the second icon controlling unit 62 shall keep the floating icon in a second icon position of the second icon page, and when the current icon display page is switched to the third icon page, the floating icon is still in a second icon position on a third icon page. The page switching module 60 automatically switches the icon display page according to the operation of switching the icon display page by the user, and switches the icon display page to a proper icon page (that is, switching the icon display page to the second icon display page from the first icon display page), the moving module 50 can respond to the touch operation of the user to the floating icon to insert the floating icon in the proper position on the current icon display page. During specific implementation, the touch operation of the user to the floating icon includes: performing point-touch on the floating icon, or dragging the floating icon or other operation manners. If the touch operation of the user to the floating icon is an operation of performing point-touch on the floating icon, the moving module 50 determines that which icon on the current icon display page (that is, the second icon display page) is the closest to the floating icon according to a current position of the floating icon, and inserts the floating icon in an icon position closest to the floating icon, and cancels the floating state of the floating icon, and deletes an icon of the floating icon in an original position, thereby completing the operation of moving the icon. If the touch operation of the user to the floating icon is an operation of dragging the floating icon, the moving module 50 determines a position in which the floating icon is released by the user according to the operation of dragging the floating icon, inserts the floating icon in the icon position, and cancels the floating state of the floating icon, and deletes the icon of the floating icon on the original position, thereby completing the operation of moving the icon.

According to the embodiment, the icon setting module 20 identifies the to-be-moved icon by detecting the touch operation of the user on the icon display page, and sets the to-be-moved icon as the floating icon; and the floating icon floats at the top of the icon layer, and is kept immovable in the original position during the process of switching the icon display page. The inclining direction or the shaking direction of the terminal is detected by using the sensor, so as to determine the operation of switching the icon display page by the user, and after the icon display page is switched to a proper icon page, the floating icon is inserted in a proper position, and exits a floating state, thereby completing the operation of moving the icon. The embodiment increases the efficiency of switching the icon display page, improves the accuracy of moving the icon, and enhances the user experience of moving the icon.

The modules or units in the embodiments of the present invention can be realized by using a general integrated circuit (for example, a central processing unit, CPU), or an application specific integrated circuit (ASIC).

The steps in the method provided in the embodiment of the present invention can be subject to sequence regulation, integration and deletion according to an actual need.

The modules or units in the apparatus provided in the embodiment of the present invention can be integrated, divided and deleted according to an actual need.

A person ordinarily skilled in the art can understand that all or partial processes in the method provided by the foregoing embodiment can be completed through instructing relevant hardware by using a computer program, the program can be stored in a computer-readable memory medium, when the program is executed, the process of the embodiments of all the foregoing methods can be included. Where, the memory medium can be a disk, an optical disk, a read-only memory (Read-Only Memory, ROM) or random access memory (Random Access Memory, RAM) and the like.

The foregoing descriptions are merely better embodiments of the present invention, but are not intended to limit the protection scope of the present invention. Equivalent variations made according to the claims of the present invention always shall fall within the protection scope of the present invention.

1. A method for moving an icon on a terminal, comprising:
setting a to-be-moved icon as a floating icon according to a touch operation of the icon on a first icon display page;
detecting an operation of switching, by a user, the icon display page, switching the icon display page according to the operation of switching, by the user, the icon display page, and keeping the floating icon immovable in an original position; and
switching the icon display page to a second icon display page, and responding to the touch operation by the user to the floating icon to insert the floating icon in a proper position on the second icon display page.

2. The method according to claim 1, wherein the step of setting a to-be-moved icon as a floating icon according to a touch operation of the icon on a first icon display page, comprises:
detecting the touch operation of the icon on the first icon display page;
according to the touch operation of the icon, determining whether there is an icon, which is pressed down, on the first icon display page;
if there is the icon, which is pressed down, on the first icon display page, determining whether time of pressing the icon down exceeds a preset time threshold; and
if the time of pressing the icon down exceeds the preset time threshold, determining that the icon is a to-be-moved icon, and setting the to-be-moved icon as a floating icon.

3. The method according to claim 2, wherein the switching the icon display page according to the operation of switching, by the user, the icon display page, comprises:
dividing the first icon display page into a left touch area and a right touch area by using an axial in which the floating icon is located as a center axis; and
detecting a touch operation of the user in the left touch area or the right touch area, if the touch operation of the user in the left touch area is detected, the icon display page is automatically switched to a previous page, and if the touch operation of the user in the right touch area is detected, the icon display page is automatically switched to a next page.

4. The method according to claim 2, wherein the switching the icon display page according to the operation of switching, by the user, the icon display page, comprises:
detecting, by using a sensor, an inclining direction or a shaking direction of a terminal when the user switches the icon display page, if the inclining direction or the shaking direction of the terminal is detected to be a left direction, the icon display page is automatically switched to a previous page, and if the inclining direction or the shaking direction of the terminal is detected to be a right direction, the icon display page is automatically switched to a next page.

5. The method according to claim 3, wherein the touch operation of the user to the floating icon in the step of responding to the touch operation by the user to the floating icon, comprises:
touching the floating icon, to insert the floating icon in an icon position that is the closest to the floating icon in the icon display page, and exit a floating state; or
dragging the floating icon, to drag the floating icon to a proper icon position and insert the floating icon in the icon position and exit the floating state.

6. A terminal, comprising:
an icon setting module, configured to set a to-be-moved icon as a floating icon according to a touch operation of an icon on a first icon display page;
a page switching module, configured to detect an operation of switching, by a user, an icon display page, switch the icon display page according to the operation of switching, by the user, the icon display page, and keep the floating icon immovable in an original position; and
a moving module, configured to switch the icon display page to a second icon display page, and respond to the touch operation by the user to the floating icon to insert the floating icon in a proper position in the second icon display page.

7. The terminal according to claim 6, wherein the icon setting module, comprises:
a detecting unit, configured to detect a touch operation of an icon on a first icon display page;
a first determining unit, configured to determine whether there is an icon, which is pressed down, on the first icon display page according to the touch operation of the icon;
a second determining unit, configured to determine whether time of pressing the icon down exceeds a preset time threshold when the first determining unit determines that there is the icon, which is pressed down, on the first icon display page; and
a setting unit, configured to determine that the icon is a to-be-moved icon and set the to-be-moved icon as a floating icon when the second determining unit determines that the time of pressing the icon down exceeds the preset time threshold.

8. The terminal according to claim 7, wherein the page switching module, comprises:
a dividing unit, configured to divide the icon display page into a left touch area and a right touch area by using an axial in which the floating icon is located as a center axis;
a first switching unit, configured to detect a touch operation of the user in the left touch area or the right touch area, if the touch operation of the user in the left touch area is detected, the icon display page is automatically switched to a previous page, and if the touch operation of the user in the right touch area is detected, the icon display page is automatically switched to a next page; and
a first icon controlling unit, configured to keep the floating icon immovable in the original position during a process of switching the icon display page by the first switching unit.

9. The terminal according to claim 7, wherein the page switching module, comprises:
a second switching unit, configured to detect, by using a sensor, an inclining direction or a shaking direction of a terminal when the user switches the icon display page, if the inclining direction or the shaking direction of the terminal is detected to be a left direction, the icon display page is automatically switched to a previous page, and if the inclining direction or the shaking direction of the terminal is detected to be a right direction, the icon display page is automatically switched to a next page; and
a second icon controlling unit, configured to keep the floating icon immovable in an original position during a process of switching the icon display page by the second switching unit.

10. The terminal according to claim 8, wherein the moving module, comprises:
a first responding unit, configured to switch the icon display page to the second icon display page, and respond to a touch operation of touching, by the user, the floating icon to insert the floating icon in an icon position that is the closest to the floating icon in the second icon display page, and enable the floating icon to exit a floating state; and
a second responding unit, configured to switch the icon display page to the second icon display page, and respond to a touch operation of dragging, by the user, the floating icon to insert the floating icon in an icon position that is selected by the user in the second icon display page, and enable the floating icon to exit the floating state.

11. The method according to claim 4, wherein the touch operation of the user to the floating icon in the step of responding to the touch operation by the user to the floating icon, comprises:
touching the floating icon, to insert the floating icon in an icon position that is the closest to the floating icon in the icon display page, and exit a floating state; or
dragging the floating icon, to drag the floating icon to a proper icon position and insert the floating icon in the icon position and exit the floating state.

12. The terminal according to claim 9, wherein the moving module, comprises:
a first responding unit, configured to switch the icon display page to the second icon display page, and respond to a touch operation of touching, by the user, the floating icon to insert the floating icon in an icon position that is the closest to the floating icon in the second icon display page, and enable the floating icon to exit a floating state; and
a second responding unit, configured to switch the icon display page to the second icon display page, and respond to a touch operation of dragging, by the user, the floating icon to insert the floating icon in an icon position that is selected by the user in the second icon display page, and enable the floating icon to exit the floating state.
